(19) United States
(12) Patent Application Publication
(10) Pub. No.: US 2026/0094239 A1
(43) Pub. Date: Apr. 2, 2026

(54) LAPLACIAN DIFFUSION FOR GENERATING IMAGES

(71) Applicant: NVIDIA CORPORATION, Santa Clara, CA (US)

(72) Inventors: Yogesh BALAJI, Mountain View, CA (US); Ting-Chun WANG, Santa Clara, CA (US); Jiaojiao FAN, Santa Clara, CA (US); Qinsheng ZHANG, Atlanta, GA (US); Xiaohui ZENG, Santa Clara, CA (US); Maciej BALA, Warsaw (PL); Yin CUI, Mountain View, CA (US); Yuval ATZMON, London (GB); Aaron LICATA, San Ramon, CA (US); Pooya JANNATY, Mountain View, CA (US); Siddharth GURURANI, Sunnyvale, CA (US); Seungjun NAH, Santa Clara, CA (US); Yu ZENG, San Jose (CA); John LEWIS, Mountain View, CA (US); Jacob Samuel HUFFMAN, San Diego, CA (US); Yunhao GE, Sunnyvale, CA (US); Fitsum REDA, Santa Clara, CA (US); Ming-Yu LIU, San Jose, CA (US)

(21) Appl. No.: 19/304,037

(22) Filed: Aug. 19, 2025

Related U.S. Application Data
(60) Provisional application No. 63/700,461, filed on Sep. 27, 2024.

(51) Int. Cl. G06T 3/4076; G06T 3/4046; G06T 5/73

(52) U.S. Cl. CPC G06T 3/4076; G06T 3/4046; G06T 5/73

(57) ABSTRACT

The disclosed method for generating images includes performing, based on one or more inputs, one or more first denoising diffusion operations using a first trained machine learning model to generate a first image at a first resolution; and performing, based on the one or more inputs and the first image, one or more second denoising diffusion operations using a second trained machine learning model to generate a second image at a second resolution.

### CROSS-REFERENCE TO RELATED APPLICATIONS

This application claims priority benefit of the United States Provisional patent application titled, “GENERATING IMAGES USING CASCADED PIXEL-SPACE DIFFUSION MODELS,” filed on Sep. 27, 2024, and having Ser. No. 63/700,461. The subject matter of this related application is hereby incorporated herein by reference.

### BACKGROUND

### Technical Field

Embodiments of the present disclosure relate generally to computer science, artificial intelligence, and machine learning, and more specifically, to Laplacian diffusion for generating images.

### Description of the Related Art

Advances in machine learning have enabled the development of machine learning models capable of generating images. One type of machine learning model, called “diffusion models,” excels at producing realistic images from text inputs. A diffusion model typically begins with pure random noise and gradually removes the noise through iterative steps, until a desired image emerges. Each of the iterative steps is guided by statistical rules learned by the diffusion model through training on a large number of example images, allowing the diffusion model to generate patterns of pixels that resemble regions in the example images.

One drawback of conventional diffusion models is that such models are typically unable to generate high resolution images. Further, conventional diffusion models oftentimes generate images with artifacts, such as anatomy or geometry errors, garbled text and symbols, texture or pattern glitches, stylistically or physically implausible objects, and/or the like. For example, as a general matter, conventional diffusion models have difficulty generating realistic images of humans. Accordingly, images that are generated by conventional diffusion models can be of lower resolution or quality than desired and, therefore, suboptimal for many desired purposes.

As the foregoing illustrates, what is needed in the art are more effective techniques for generating images.

### SUMMARY

One embodiment of the present disclosure sets forth a computer-implemented method for generating images. The method includes performing, based on one or more inputs, one or more first denoising diffusion operations using a first trained machine learning model to generate a first image at a first resolution. The method further includes performing, based on the one or more inputs and the first image, one or more second denoising diffusion operations using a second trained machine learning model to generate a second image at a second resolution.

Another embodiment of the present disclosure sets forth a computer-implemented method for training a machine learning model. The method includes re-sizing a training image based on a selected noise level to generate a re-sized image, and adding noise of the selected noise level to the re-sized image to generate a noisy image. The method further includes processing the noisy image using a first untrained machine learning model to generate a clean image. In addition, the method includes updating one or more parameters of the first untrained machine learning model based on the training image and the clean image to generate a first trained machine learning model. The first trained machine learning model performs one or more denoising diffusion operations at a plurality of resolutions to generate a first image.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques can generate high-resolution images, including 4K images and panoramic images. In addition, the disclosed techniques can generate images with fewer artifacts relative to images generated using conventional diffusion models. For example, the disclosed techniques can generate relatively realistic and high-resolution images of humans. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 is a more detailed illustration of the image generating application of FIG. 1, according to various embodiments;

FIG. 5 is a more detailed illustration of the Laplacian diffusion model of FIG. 4, according to various embodiments;

FIG. 6 illustrates a forward noising process, according to various embodiments;

FIG. 7 illustrates a backward sampling process, according to various embodiments;

FIG. 8 is a more detailed illustration of a diffusion model of FIG. 5, according to various embodiments;

FIG. 9 is a more detailed illustration of a diffusion model of FIG. 5, according to various other embodiments;

FIG. 10 illustrates an exemplar image generated using a Laplacian diffusion model, according to various embodiments;

FIG. 11 illustrates an exemplar upsampling of an image using a Laplacian diffusion model, according to various embodiments;

FIG. 12 illustrates exemplar images generated using a Laplacian diffusion model conditioned on depth information, according to various embodiments;

FIG. 13 illustrates exemplar images generated using a Laplacian diffusion model conditioned on edge information, according to various embodiments;

FIG. 14 illustrates an exemplar panoramic image generated using a Laplacian diffusion model, according to various embodiments;

FIG. 15 illustrates exemplar images of a same subject generated using a Laplacian diffusion model, according to various embodiments;

FIG. 16 illustrates an exemplar panoramic image generated using a Laplacian diffusion model, according to various embodiments;

FIG. 17 is a flow diagram of method steps for training a Laplacian diffusion model, according to various embodiments;

FIG. 18 is a flow diagram of method steps for fine tuning a Laplacian diffusion model, according to various embodiments;

FIG. 19 is a flow diagram of method steps for generating an image using a Laplacian diffusion model, according to various embodiments;

FIG. 20 is a flow diagram of method steps for performing Laplacian diffusion to generate an image at a first resolution, according to various embodiments; and

FIG. 21 is a flow diagram of method steps for generating panoramic images, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating images using Laplacian diffusion. In some embodiments, an image generating application includes one or more diffusion models that each perform a Laplacian diffusion technique that includes progressively denoising images and upsampling the images to higher resolutions at the same time. When multiple diffusion models are used, one diffusion model can generate an image at a low resolution. The image generating application upsamples the generated image to a higher resolution and performs forward diffusion to add noise to the upsampled image. Another diffusion model begins Laplacian diffusion from the noisy upsampled image to generate another image. The foregoing steps can be repeated any number of times to generate images at increasingly higher resolutions. In some embodiments, each diffusion model can include one or more encoders, such as ControlNet encoders, that permit the generation of images in various styles and/or based on various conditioning information, such as a lower-resolution image, depth information, or edge information. In some embodiments, the conditioning information can include an image for which an image of a neighboring region is to be generated, and images of neighboring regions can be generated in a successive manner and stitched together to generate a panoramic image.

To train a diffusion model, a model trainer receives an image from training data. The model trainer re-sizes the training image based on a randomly selected noise level to generate a re-sized image. The model trainer adds the selected level of noise to the re-sized image to generate a noisy image. The model trainer processes the noisy image using a denoising network to generate a clean image. Then, the model trainer computes a loss based on a difference between the clean image and the image from the training data, and the model trainer updates parameters of the denoising network based on the computed loss. The foregoing steps can be repeated for multiple training images to train the diffusion model. Thereafter, the model trainer can fine-tune the trained diffusion model for higher resolutions to generate other trained diffusion models. Optionally, the model trainer can also train one or more models that include the trained denoising network and one or more ControlNet encoders by updating parameters of the ControlNet encoder(s) while keeping parameters of the trained denoising network frozen during the training.

The techniques for generating images have many real-world applications. For example, those techniques could be applied to generate images for various media such as books, magazines, websites, movies, video games, virtual reality (VR) or augmented reality (AR) experiences, etc. As another example, the techniques for generating images can be used to generate images for image-based lighting (IBL).

The above examples are not in any way intended to be limiting. As persons skilled in the art will appreciate, as a general matter, the techniques for generating images can be implemented in any suitable application.

### System Overview

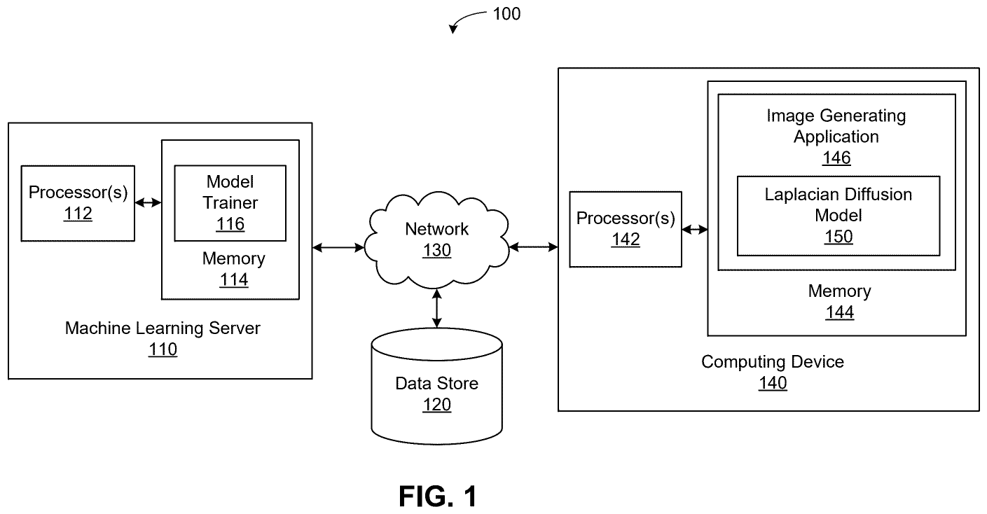

FIG. 1 illustrates a block diagram of a computer-based system 100 configured to implement one or more aspects of at least one embodiment. As shown, the system 100 includes a machine learning server 110, a data store 120, and a computing device 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor(s) 112 receive user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor(s) 112 and/or the GPU(s). For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

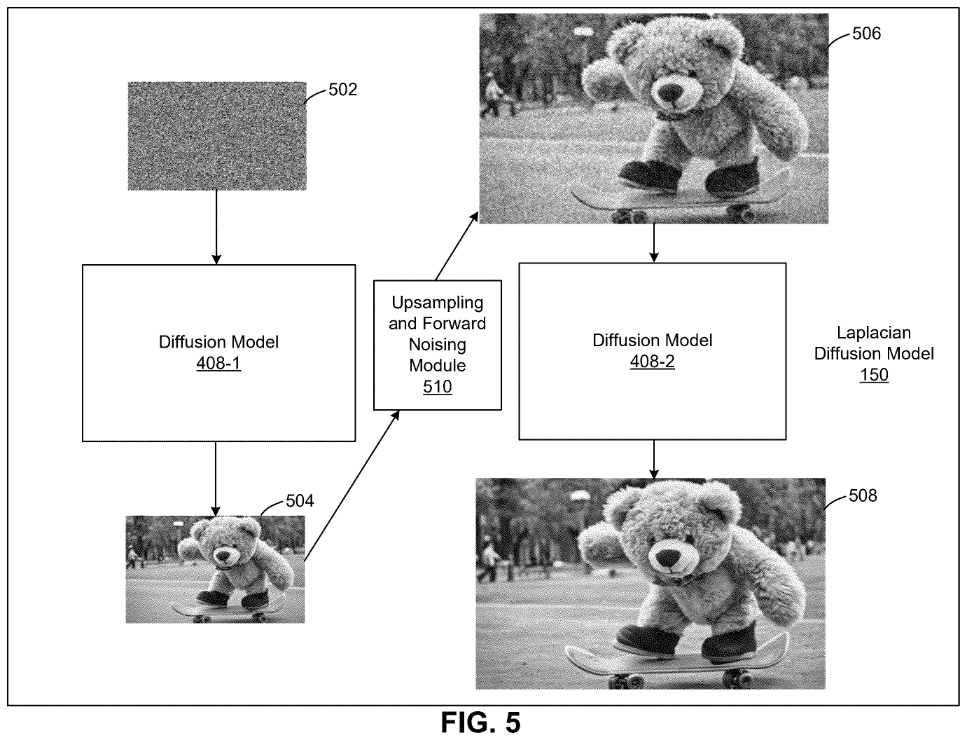

In some embodiments, the model trainer 116 is configured to train one or more machine learning models, including a Laplacian diffusion model 150 that is trained to generate images. Techniques for training the Laplacian diffusion model 150 are discussed in greater detail below in conjunction with FIGS. 5-9, 11, and 14-18. Training data and/or trained machine learning models, including the Laplacian diffusion model 150, can be stored in the data store 120, or elsewhere. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

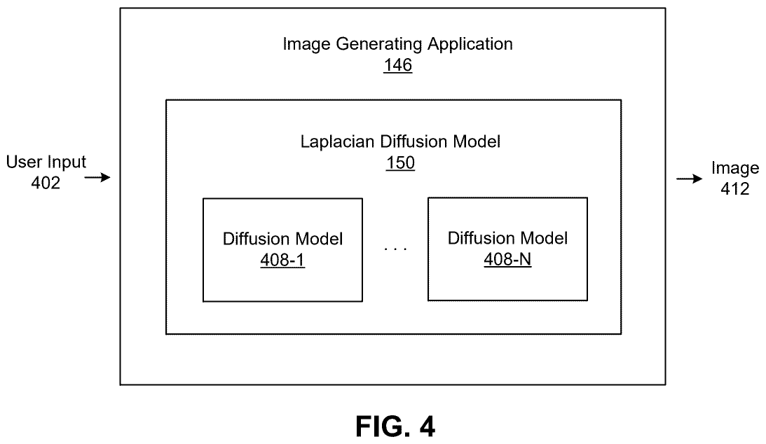

As shown, an image generating application 146 that uses the trained Laplacian diffusion model 150 is stored in a memory 144, and executes on processor(s) 142, of the computing device 140. The memory 144 and the processor(s) 142 may be similar to the memory 114 and the processors 112, respectively, of the machine learning server, described above. The image generating application 146 can use the trained Laplacian diffusion model 150 to generate images, as discussed in greater detail below in conjunction with FIGS. 4-16 and 19-21.

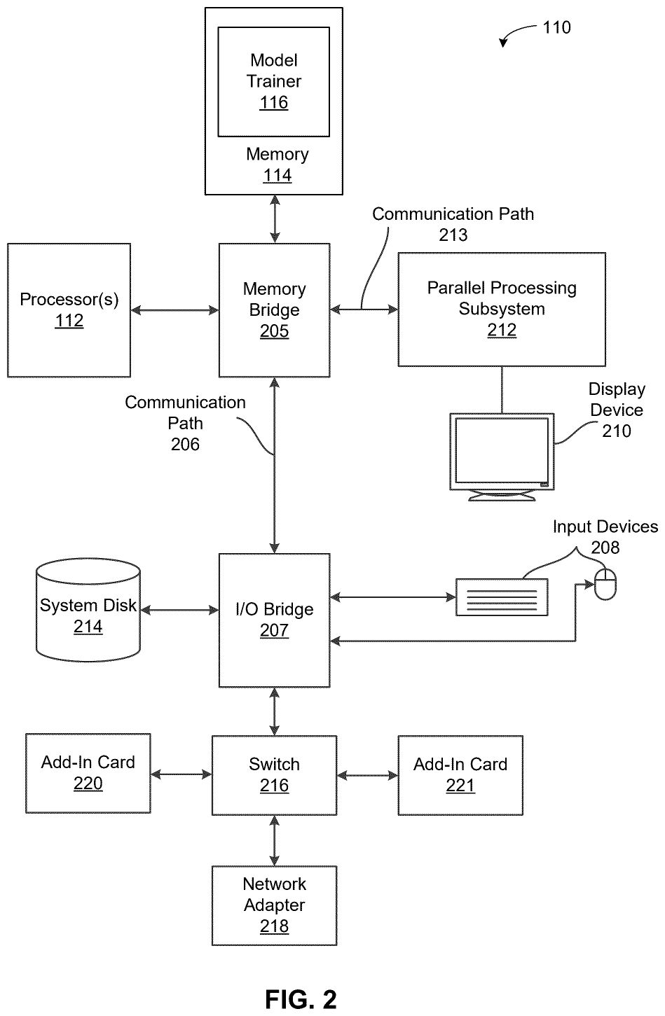

FIG. 2 is a block diagram illustrating the machine learning server 110 of FIG. 1 in greater detail, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network. In some embodiments, the machine learning server 110 can include one or more similar components as the machine learning server 110.

In various embodiments, the machine learning server 110 includes, without limitation, the processor(s) 112 and the memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor(s) 112 and other connection circuitry on a single chip to form a system on a chip (SoC).

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 202, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor(s) 112. In other embodiments, parallel processing subsystem 212 may be connected to I/O bridge 207 or directly to processor(s) 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

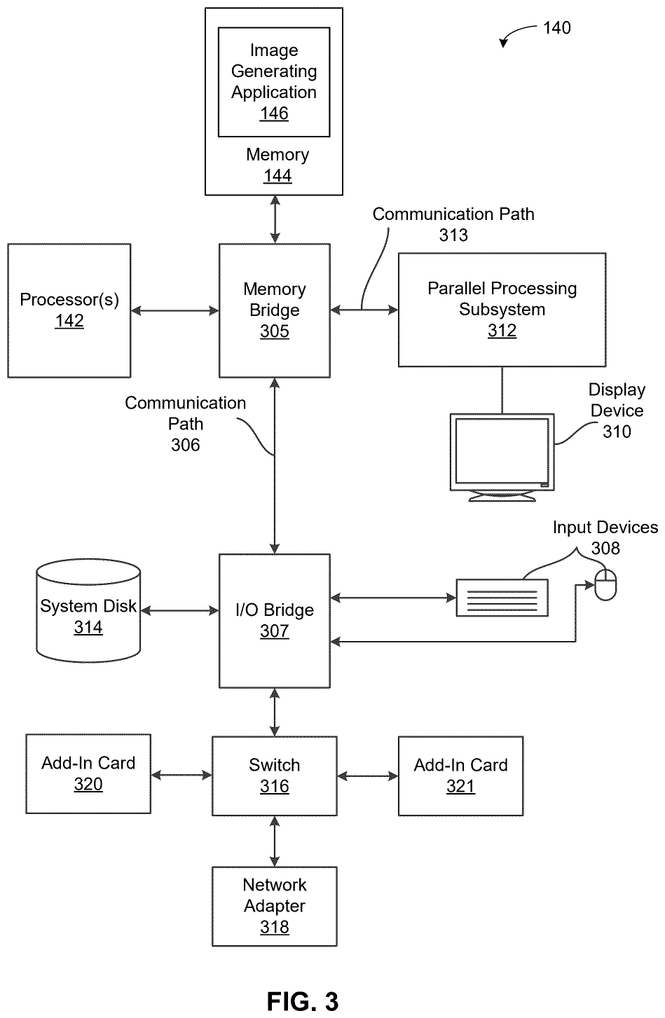

FIG. 3 is a block diagram illustrating the computing device 140 of FIG. 1 in greater detail, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing device 140 is a server machine operating in a data center or a cloud computing environment that provides scalable computing resources as a service over a network. In some embodiments, the machine learning server 110 can include one or more similar components as the computing device 140.

In various embodiments, the computing device 140 includes, without limitation, the processor(s) 142 and the memory(ies) 144 coupled to a parallel processing subsystem 312 via a memory bridge 305 and a communication path 313. Memory bridge 305 is further coupled to an I/O (input/output) bridge 307 via a communication path 306, and I/O bridge 307 is, in turn, coupled to a switch 316.

In one embodiment, I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, computing device 140 may not include input devices 308, but may receive equivalent input information by receiving commands (e.g., responsive to one or more inputs from a remote computing device) in the form of messages transmitted over a network and received via the network adapter 318. In some embodiments, switch 316 is configured to provide connections between I/O bridge 307 and other components of the computing device 140, such as a network adapter 318 and various add-in cards 320 and 321.

In some embodiments, I/O bridge 307 is coupled to a system disk 314 that may be configured to store content and applications and data for use by processor(s) 142 and parallel processing subsystem 312. In one embodiment, system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 307 as well.

In various embodiments, memory bridge 305 may be a Northbridge chip, and I/O bridge 307 may be a Southbridge chip. In addition, communication paths 306 and 313, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and/or compute processing operations. System memory 144 includes at least one device driver configured to manage the processing operations of the one or more PPUs within parallel processing subsystem 312. In addition, the system memory 144 includes the image generating application 146. Although described herein primarily with respect to the image generating application 146, techniques disclosed herein can also be implemented, either entirely or in part, in other software and/or hardware, such as in the parallel processing subsystem 312.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, the processor(s) 142 issues commands that control the operation of PPUs. In some embodiments, communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 302, and the number of parallel processing subsystems 312, may be modified as desired. For example, in some embodiments, system memory 144 could be connected to the processor(s) 142 directly rather than through memory bridge 305, and other devices may communicate with system memory 144 via memory bridge 305 and processor 142. In other embodiments, parallel processing subsystem 312 may be connected to I/O bridge 307 or directly to processor 142, rather than to memory bridge 305. In still other embodiments, I/O bridge 307 and memory bridge 305 may be integrated into a single chip instead of existing as one or more discrete devices. In certain embodiments, one or more components shown in FIG. 3 may not be present. For example, switch 316 could be eliminated, and network adapter 318 and add-in cards 320, 321 would connect directly to I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in at least one embodiment. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Laplacian Diffusion for Generating Images

FIG. 4 is a more detailed illustration of the image generating application 146 of FIG. 1, according to various embodiments. As shown, the image generating application 146 includes, without limitation, the Laplacian diffusion model 150. The Laplacian diffusion model 150 includes, without limitation, diffusion models 408-1 to 408-N (referred to herein collectively as diffusion models 408 and individually as a diffusion model 408). Any number of diffusion models 408 can be used in some embodiments, including a single diffusion model 408.

In operation, the image generating application 146 receives user input 402, and the Laplacian diffusion model 150 generates an image 412 conditioned on the user input 402. Any suitable user input 402 can be received and used to condition the generation of the image 412. For example, in some embodiments, the user input 402 can include text, camera attributes, a media type, a low-resolution image, an image for inpainting, a depth map, edges, and/or the like.

In some embodiments, to generate the image 412, each diffusion model 408 performs a Laplacian diffusion technique. As used herein, “Laplacian diffusion” refers to a progressive denoising technique that uses denoising diffusion to denoise images and upsamples the images to higher resolutions at the same time. In some embodiments, each diffusion model 408 begins with a noisy image at a low resolution, and iteratively denoises the image for a number of iterations (which is a tunable parameter), increases the resolution of the image, iteratively denoises the image for another number of iterations (which is another tunable parameter) at the increased resolution, and repeats the foregoing steps, until a clean image at a higher resolution that does not include noise is generated. During each iterative denoising diffusion step, a trained denoising network (not shown) in the diffusion model 408 processes the user input 402 and a noisy input image to generate a clean image. Then, a smaller amount of noise is added to the clean image based on the resolution level, with more noise added for lower resolutions and less noise added for higher resolutions.

In addition, diffusion model 408-1 is a base model that generates an image at a particular resolution (e.g., 256 resolution) based on the user input 402. Each subsequent diffusion model 408-2 to 408-N is an upsampler model that generates an image at a successively higher resolution based on (1) the user input 402, and (2) a version of the image generated by a previous diffusion model 408 to which noise has been added, as discussed in greater detail below in conjunction with FIG. 5. For example, the diffusion model 408-2 could be an upsampler model that generates 1024 resolution images. Use of multiple diffusion models 408, as opposed to a single diffusion model 408, provides more capacity in the neural networks of the diffusion models 408 because the multiple neural networks will include more parameters when combined. In some embodiments, the upsampler diffusion models 408 can be fine-tuned versions of the base diffusion model 408-1 that are fine-tuned to generate higher-resolution images.

In some embodiments, each of the diffusion models 408 can include one or more ControlNet encoders that permit the generation of images in various styles and/or based on various conditioning information, such as a lower-resolution image, depth information, or edge information. In some embodiments, the conditioning information can include an image for which an image of a neighboring region is to be generated, and images of neighboring regions can be generated in a successive manner and stitched together to generate a panoramic image.

FIG. 5 is a more detailed illustration of the Laplacian diffusion model 150 of FIG. 4, according to various embodiments. As shown, the Laplacian diffusion model 150 includes, without limitation, a diffusion model 408-1, a diffusion model 408-2, and an upsampling and forward noising module 510. Although two diffusion models 408-1 and 408-2 are shown for illustrative purposes, the Laplacian diffusion model 150 can include any number of diffusion models in some embodiments.

In operation, the diffusion model 408-1 performs a Laplacian diffusion technique starting from an image 502 of random noise at a first resolution that is relatively low. The Laplacian diffusion technique includes the diffusion model 408-1 downsampling the image 502 of random noise to a smaller resolution and then progressively performing denoising diffusion while increasing a resolution of the image, until a clean image 504 is generated. Then, the upsampling and forward noising module 510 upsamples the clean image 504 to a higher resolution and performs forward diffusion to add noise to the upsampled image, thereby generating a noisy image 506 at the higher resolution. Thereafter, the diffusion model 408-2 performs the Laplacian diffusion technique beginning from the noisy image 506 to generate a clean image 508 at the higher resolution.

More specifically, each diffusion model 408 simulates a resolution-varying diffusion process in the time domain by simultaneously decaying different image frequency bands at different rates. In general, given an image data distribution p₀(x₀), where x₀ ∈χ, a diffusion model derives a family of distributions pₜ(xₜ) by injecting independent and identically distributed Gaussian noise into data samples during the diffusion forward process, such that xₜ=x₀+σₜϵ with ϵ˜ [symbol] (0,I) and σₜ monotonically increasing with respect to time t∈[0,T]. To simulate the diffusion backward sampling process, which generates samples by iteratively removing noise starting from Gaussian noise, diffusion models obtain the score function ∇ₓ_{ₜ} log pₜ(xₜ) (i.e., the gradient of log-probability) via a denoising score matching objective:

$${L}_{t} ( θ ) = {𝔼}_{{x}_{0} , {x}_{t}} [ {‖ {D}_{θ} ( {x}_{t} , t ) - {x}_{0} ‖}_{2}^{2} ] , \qquad ( 1 )$$

where D_{θ}: [symbol] ×[0,T]→ [symbol] is a time-conditioned neural network that tries to denoise the noisy sample xₜ. Assuming an infinite capacity of D_{θ}, the predictions of the optimal model are related to the score function via Tweedie's formula:

$${\hat{x}}_{t} : = {D}_{θ} ( {x}_{t} , t ) = {x}_{t} + {σ}_{t}^{2} {∇}_{{x}_{t}} log {p}_{t} ( {x}_{t} ) , \qquad ( 2 )$$

which represents the minimum mean squared error (MMSE) estimator of x₀ given xₜ and σₜ. The precondition design for D_{θ}(xₜ, t) and log normal distribution a can be followed during training in some embodiments.

Further, image Laplacian decomposition is a multi-scale representation technique that decomposes an image into a series of progressively lower-resolution images, capturing different frequency bands at each level. The hierarchical structure of image Laplacian decomposition includes a sequence of band-pass filtered images, where each level represents the difference between two successive versions of the original image. Specifically, a simple image downsampling operation is a way to obtain the low-frequency component, where high-frequency details from the original image are effectively removed. Upsampling and downsampling operations are denoted herein as up(.) and down(.), respectively. Through such a decomposition, for simplicity, assume there are three resolution stages, i.e. x=x⁽¹⁾+up(x⁽²⁾)+up (up(x⁽³⁾)), where:

$${x}^{( 3 )} = down ( down ( x ) ) , \qquad ( 3 )$$

$${x}^{( 2 )} = down ( x ) - up ( {x}^{( 3 )} ) ,$$

$${x}^{( 1 )} = x - up ( down ( x ) ) .$$

Note that even when a d dimensional vector is used to present x⁽ⁱ⁾, the internal representation can be more compact. For example, a downsampled d/16 dimensional vector can be used to represent x⁽³⁾ to tackle high-resolution image synthesis.

Each diffusion model 408 performs the Laplacian diffusion technique, described above, that is built upon the image Laplacian decomposition described above using an intuitive approach. The Laplacian diffusion technique explicitly controls how image signals at different frequency bands are attenuated and synthesized at varying rates rather than entangling such signals at different frequency bands together and allowing them to be corrupted through an implicit approach. A rigorous treatment can be derived with stochastic differential equations. Although described herein primarily with respect to the 3-stage image Laplacian decomposition in Equation (3) as a reference example, the same formulation can be extended to more stages.

In some embodiments, the Laplacian diffusion model 150 can be a two-stage cascaded pixel-space diffusion model where the first diffusion model 408-1 generates an image at one resolution (e.g., 256 resolution) while the second diffusion model 408-1 upscales the image to a higher resolution (e.g., 1024 resolution). In such cases, the diffusion model 408-1 can be trained on the full noise range (e.g., [0,

$${σ}_{256}^{m ax}$$

]), while the diffusion model 408-2 operates on a smaller noise range (e.g.,

$$[ 0 , {σ}_{1024}^{m ax} ] ( {σ}_{1024}^{m ax} < {σ}_{256}^{m ax} ) ) .$$

During inference, the Laplacian diffusion model 150 can first generate a lower-resolution image by running the full sampling loop on the base diffusion model 408-1. Then, the diffusion model 408-1 can apply forward diffusion on the generated image

$$( e . g . , with σ = {σ}_{1024}^{m ax} )$$

and denoise the image using the upsampler diffusion model 408-2.

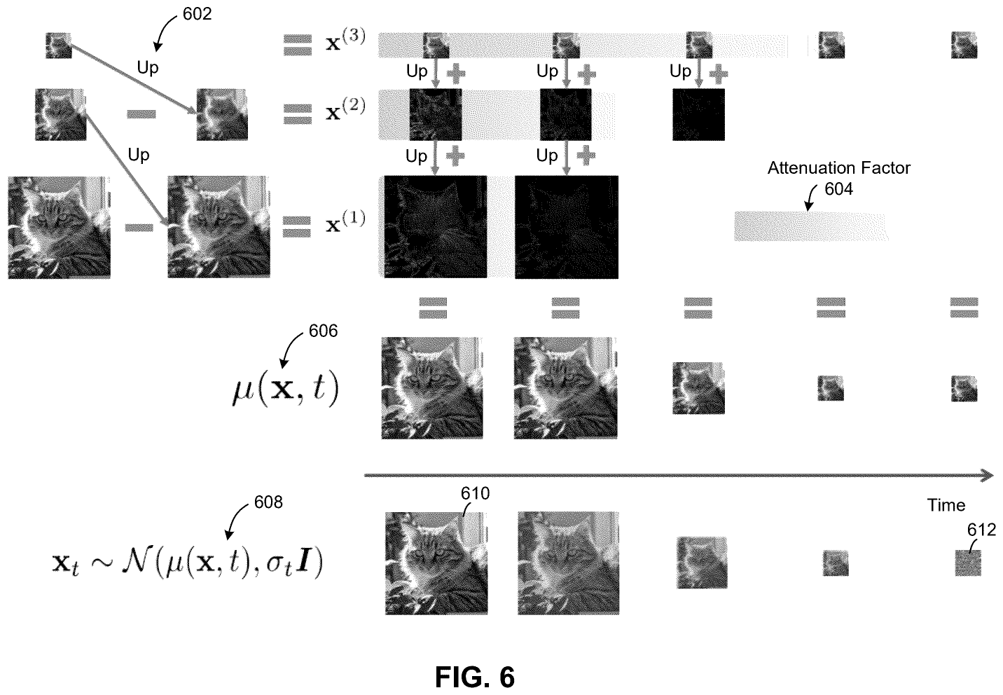

FIG. 6 illustrates a forward noising process, according to various embodiments. As shown, during forward noising, using which the Laplacian diffusion model 150 can be trained, noise is added to an image sample 610 and the image sample 610 is reduced in resolution over time, generating a noisy image at a lower resolution 612. Also shown is an image pyramid 602 and a Laplacian decomposition that decomposes the image sample 610 into a set of components, shown as three components x⁽¹⁾+up(x⁽²⁾)+up (up(x⁽³⁾)). In some embodiments, the Laplacian decomposition can be implemented using upsampling and downsampling operations, where each component corresponds to different frequency bands. The function μ(x,t) 606 represents a weighted sum of these components across different frequency spaces. During forward noising, components are attenuated at different rates, with higher frequencies attenuated more rapidly than lower ones. An attenuation factor 604 is shown as a decaying background color. As a result of the attenuation of components at different rates, the signal-to-noise ratio (SNR) diminishes faster in high-frequency components, allowing the high-frequency components to be discarded without significant loss of information once attenuation coefficients of the high-frequency components approach zero.

More specifically, the forward noising process can be a generalization of the isotropic forward process utilized in standard diffusion models, where xₜ˜ [symbol] (x₀,σₜI), to a more flexible formulation: xₜ˜ [symbol] (μ(x₀,t),σₜI) 608. Here, μ is defined as:

$$μ ( {x}_{0} , t ) = {\sum }_{i = 1}^{3} {α}_{t}^{( i )} {x}_{0}^{( i )} , \qquad ( 4 )$$

where the coefficients

$${α}_{t}^{( i )}$$

are attenuation factors. The attenuation factors can be defined to be monotonically non-increasing with respect to the diffusion time t. The forward process can also be expressed as the summation of three diffusion models operating in different subspaces:

$${x}_{t} = {\sum }_{i = 1}^{3} {α}_{t}^{( i )} {x}_{0}^{( i )} + {σ}_{t} ϵ = {\sum }_{i = 1}^{3} {α}_{t}^{( i )} {x}_{0}^{( i )} + {σ}_{t} {ϵ}^{( i )} , \qquad ( 5 )$$

where ϵ⁽ⁱ⁾ can be obtained via the Laplacian decomposition as in Equation (3). Most conventional diffusion models choose

$${α}_{t}^{( i )}$$

that are invariant to subspace, thereby entangling the three components at any given time t. Consequently, the denoising network is required to operate across all three subspaces to reconstruct the original signals for all diffusion processes. In some embodiments, a diffusion model 408 uses distinct rates for the

$${α}_{t}^{( i )} ,$$

such that the components in the high-frequency branch decay more rapidly than the components in the lower-frequency branch. Two critical time points are t^{(1*)} and t^{(2*)}, at which

$${α}_{t}^{( 1 )} and {α}_{t}^{( 2 )}$$

respectively diminish to zero. Beyond such timestamps, a more compact, low-resolution representation suffices for the signal, as the high-frequency components no longer contribute to xₜ.

To train the denoising network in each diffusion model 408, the model trainer 116 can use the same loss function, as defined in Equation (1), to train the denoising network D_{θ}(xₜ,t). However, the Laplacian forward process introduces greater flexibility in network design, allowing operations across different resolution ranges. Moreover, the Laplacian forward process greatly improves training efficiency by separating the low-frequency and high-frequency components of the image, allowing the model to adapt more quickly. Illustratively, the model trainer 116 can train a large network for the whole time interval: [0, ∞). Alternatively, the model trainer 116 can employ a mixture of experts approach, where a low-resolution denoising network (also referred to herein as a “denoiser”)

$${D}_{θ}^{( 3 )}$$

is trained on [symbol] ⁽³⁾ for the entire time range [0, ∞), a mid-resolution denoiser

$${D}_{θ}^{( 2 )}$$

is trained on [symbol] ⁽²⁾∪ [symbol] ⁽³⁾ for the interval [0,t^{(2*)}), and a high-resolution denoiser

$${D}_{θ}^{( 1 )}$$

is trained on [symbol] for the interval [0,t^{(1*)}).

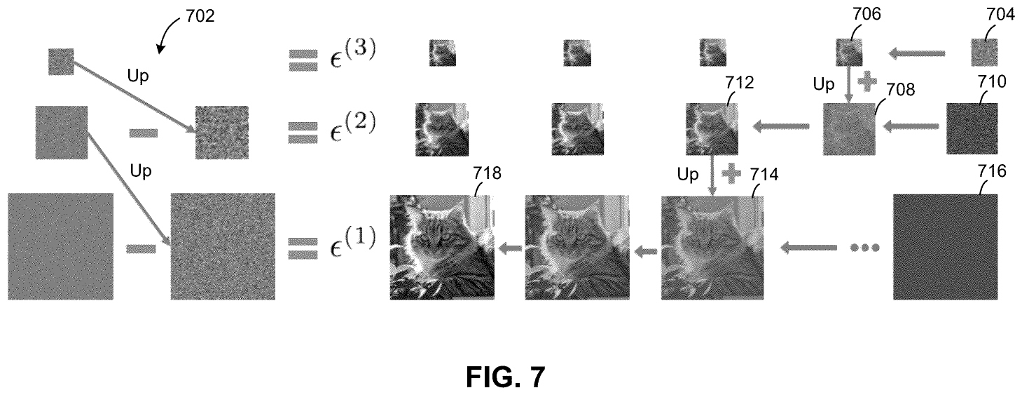

FIG. 7 illustrates a backward sampling process, according to various embodiments. As shown, the backward sampling process begins with a noisy image 704 at a low resolution. A diffusion model 408 performs denoising diffusion for a number of iterations starting from the noisy image 704 to generate a denoised image 706 at the low resolution. The diffusion model 408 upsamples the denoised image 706 to a higher resolution and adds noise 710 to the upsampled image to generate a noisy image 708 at the higher resolution. The diffusion model 408 (or another diffusion model 408) performs denoising diffusion for a number of iterations starting from the noisy image 708 to generate a denoised image 712 at the higher resolution. The diffusion model 408 upsamples the denoised image 712 to a next higher resolution and adds noise 716 to the upsampled image to generate a noisy image 714 at the next higher resolution. The diffusion model 408 (or another diffusion model 408) performs denoising diffusion for a number of iterations starting from the noisy image 714 to generate a denoised image 718 at the next higher resolution.

As described, diffusion models 408 can be trained at multiple stages to generate images at various resolutions. FIG. 7 also shows a decomposition of noise into a noise Laplacian pyramid 702. The Laplacian diffusion process synthesizes higher-resolution images by first upsampling a lower-resolution noisy sample and then denoising the noisy sample, with random noise injected into the corresponding components during upsampling. When operating solely at the lowest resolution, the process reduces to standard EDM. Accordingly, Laplacian diffusion offers a flexible approach to synthesizing images at various resolutions because of the Laplacian decomposition and the ability to utilize a mixture of denoiser experts trained across different denoising ranges.

More specifically, in the case of three resolution stages, to synthesize a lowest resolution images in [symbol] ⁽³⁾, the backward sampling process simplifies to that of regular diffusion models, as the backward sampling process involves only a single stage based on

$${D}_{θ}^{( 3 )} .$$

For generating mid-resolution images, the image generating application 146 can combine the outputs of the denoisers

$${D}_{θ}^{( 3 )} and {D}_{θ}^{( 2 )} .$$

Specifically, the image generating application 146 can perform backward sampling in χ⁽³⁾ up to t⁽²⁾*, then transition to using

$${D}_{θ}^{( 2 )}$$

to complete the remaining sampling trajectory. To synthesize the highest resolution images, the image generating application 146 can switch the sampling trajectory from

$${D}_{θ}^{( 2 )}$$

at the sampling timestamp t⁽¹⁾*, and rely on

$${D}_{θ}^{( 1 )}$$

to generate the remaining high-resolution details.

When synthesizing low-resolution images, the signals from the high-frequency band can be disregarded to reduce computational costs. Such an approach is justified by the fact that the signal-to-noise ratio is zero during the corresponding time interval. However, to synthesize high-resolution images, it is necessary to switch the sampling trajectory by upsampling the noisy image xₜ and reintroducing the high-frequency noise components. For example, consider a low-resolution image (r) and assume a noise level σ (under resolution r). Transitioning to a high-resolution (R) image with a noise level R/r·σ involves two steps: first, upscale the low-resolution image to high resolution, and second, add the corresponding high-resolution Gaussian noise component, multiplied by (σ·R/r).

The above approach can be justified using a concrete example. Consider that a noisy state xₜ at resolution (r) can be decomposed as:

$${x}^{( r )} + {σϵ}^{( r )} , \qquad ( 6 )$$

where ϵ^{(r)} is the resolution-r standard Gaussian noise. Define ϵ^{(R)} to be the standard Gaussian noise of resolution R, such that:

$${ϵ}^{( r )} = down ( {ϵ}^{( R )} , R / r ) \cdot R / r , \qquad ( 7 )$$

where the coefficient is due to the averaging of Gaussian noise. Doing so gives:

$${\underbrace{up ( {x}^{( r )} + {σϵ}^{( r )} )}}_{upscale} + {\underbrace{σ R / r \cdot ( {ϵ}^{( R )} - up ( down ( {ϵ}^{( R )} , R / r ) )}}_{add noise} \qquad ( 8 )$$

$$= up ( {x}^{( r )} ) + σ R / r \cdot {ϵ}^{R} + σ \cdot up ( {ϵ}^{( r )} - down ( {ϵ}^{( R )} , R / r ) \cdot R / r ) \qquad ( 9 )$$

$$= up ( {x}^{( r )} ) + σ R / r \cdot {ϵ}^{R} , \qquad ( 10 )$$

where the last equality is from Eq. (7). Here, the low-resolution Gaussian noise has been translated to high-resolution Gaussian noise.

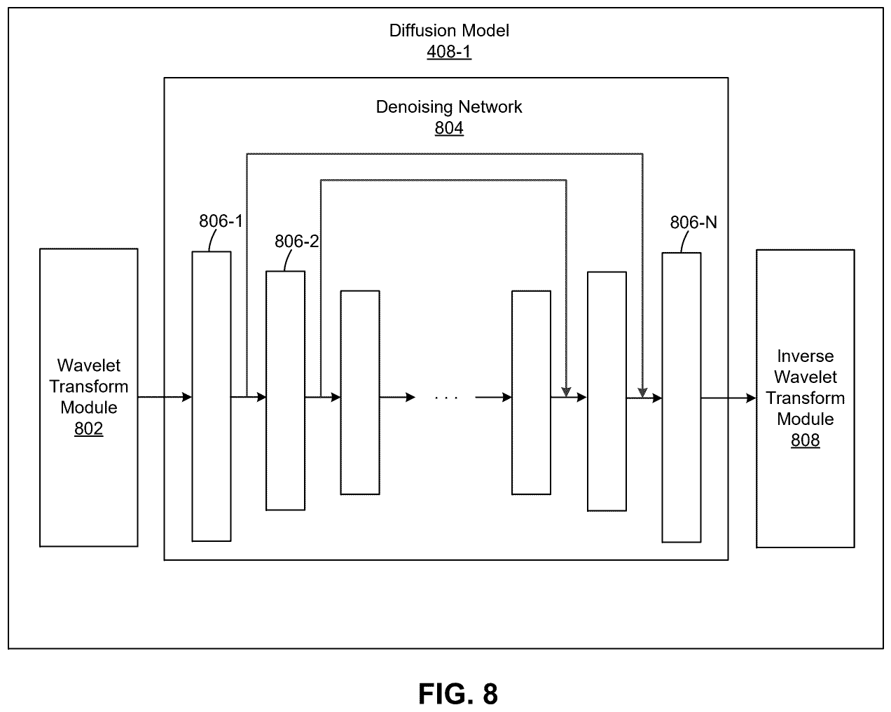

FIG. 8 is a more detailed illustration of the diffusion model 408-1 of FIG. 5, according to various embodiments. As shown, the diffusion model 408-1 includes, without limitation, a wavelet transform module 802, a denoising network 804, and an inverse wavelet transform module 808. The denoising network 804 is a neural network that includes, without limitation, a number of blocks 806-1 to 806-N (referred to herein collectively as blocks 806 and individually as a block 806). Each block 806 can include one or more layers of the neural network.

In operation, the wavelet transform module 802 performs a wavelet transform on an input image to generate a lower resolution image. Any technically feasible wavelet transform, such as a Haar wavelet transform, can be performed in some embodiments. Initially, the wavelet transform is performed on a noisy image (e.g., the noisy image 502) to generate a lower resolution (i.e., downsampled) version of the noisy image. The lower resolution image is then input into the denoising network 804, and the lower resolution image is processed via the blocks 806 of the denoising network 804. The denoising network 804 can have any technically feasible architecture, such as an encoder-decoder architecture (e.g., a U-Net architecture), in some embodiments. The denoising network 804 generates a clean image. The inverse wavelet transform module 808 performs an inverse wavelet transform on the clean image to generate a higher resolution (i.e., upsampled) image. Thereafter, if the denoising diffusion process is to continue, then the diffusion model 408-1 can add noise to the higher resolution image based on the current resolution level and then input the noisy higher resolution image into the wavelet transform module 802, and the foregoing steps can be repeated during the Laplacian diffusion technique, described above, that includes progressively denoising images while upsampling the images to higher resolutions.

In some embodiments, the denoising network 804 can include a U-Net-based architecture. In such cases, the U-Net architecture can include a sequence of residual and attention blocks that progressively downsample (or upsample) feature maps with skip connections. For high-resolution synthesis, the spatial resolution of feature maps increases, which makes the computation of attention maps expensive. To address such an issue, the diffusion model 408-1 can operate on the smaller spatial resolution by using invertible wavelet transforms, namely wavelet transforms performed by the wavelet transform modules 802 and 808, at the beginning and the end of the denoising network 804. In some embodiments, 2-level Haar wavelets can be used to downsample the images in the pixel space from resolution (3×H×W) to (48×(H/4)×(W/4)). Doing so reduces the number of spatial tokens in the attention layers of the denoising network 804 by a factor of 16, dramatically improving the training efficiency.

To provide controllability, any technically feasible conditioning inputs can be used in some embodiments. In some embodiments, text embeddings, such as text embeddings from the T5-XXL model, can be used as conditioning inputs. In such cases, to enable support for long prompt generation, the text embeddings can have a sequence length of 512. In some embodiments, to provide better camera control while generating images, the synthesis can additionally be conditioned using camera attributes. In such cases, for each image, integer-valued pitch and depth of field annotations can be passed through an embedding layer and used as a conditional signal during training. In some embodiments, each image in a dataset is assigned a media type label such as “Photography” or “Illustration,” which is then used as a conditional attribute during training. In some embodiments, conditional embeddings can be generated from user inputs via encoders (not shown), and the conditional embeddings are then concatenated along the sequence dimension and used in the cross-attention layer in the denoising network 804. During training, random embedding dropout can be applied to each of the conditional embeddings. Doing so ensures that the model can generate images using any combination of conditional signals. When all embeddings are dropped out, the unconditional score is obtained.

In some embodiments, in addition to ground truth captions, the model trainer 116 uses large language model (LLM) based captioners to obtain long descriptive captions. In such cases, during training, the model trainer 116 randomly samples captions from ground truth and AI generations. Doing so allows a diffusion model 408 to generate images from both long and short text prompts.

In some embodiments, a diffusion model 408 supports various aspect ratios, such as the five common aspect ratios of 1:1, 4:3, 3:4, 16:9, and 9:16. In such cases, image samples in the training dataset can be first grouped into one of the five bins according to the closest aspect ratio. During each training iteration, the model trainer 116 randomly samples a batch of examples from a bin and trains a diffusion network. The model trainer 116 provides the aspect ratio information to the diffusion network being trained using learnable spatial positional encodings. The positional encoding parameters are defined for the base 1:1 aspect ratio. For all other aspect ratios, the model trainer 116 performs spatial interpolation to the required feature dimensions.

In some embodiments, the model trainer 116 can perform training using the AdamW optimizer with a constant learning rate and a warmup. In some embodiments, after a predefined number of training iterations (e.g., 1.5 M iterations), the model trainer 116 can use aesthetic weighted training, in which loss per sample is multiplied by a normalized aesthetic score computed using an aesthetic model.

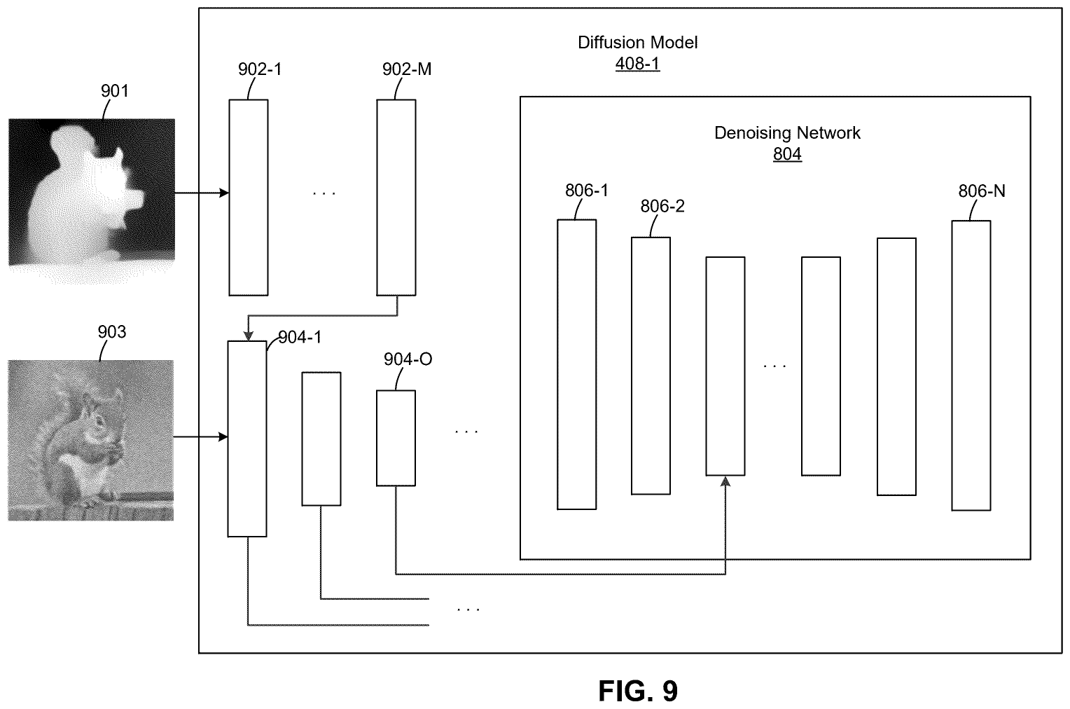

FIG. 9 is a more detailed illustration of the diffusion model 408-1 of FIG. 5, according to various other embodiments. As shown, in some embodiments the diffusion model 408-1 can include, without limitation, the denoising network 804 that includes the blocks 806, a number of hint input blocks 902-1 to 902-M (referred to herein collectively as hint input blocks 902 and individually as a hint input block 902), and a number of image input blocks 904-1 to 904-0 (referred to herein collectively as image input blocks 904 and individually as image input blocks 904). The diffusion model 408-1 can also include wavelet transform and inverse wavelet transform modules (not shown), similar to the wavelet transform module 802 and the inverse wavelet transform module 808 described above in conjunction with FIG. 8.

In operation, the hint input blocks 902 and the image input blocks 904 process conditional information, shown as depth information 901 and an image 903, respectively. The hint input blocks 902 and the image input blocks 904 generate feature maps that are added to features from a noisy image that is input into the denoising network 804, and the denoising network 804 generates a clean image as output.

In some embodiments, the hint input blocks 902 and the image input blocks 904 can be implemented as ControlNet encoders. In such cases, the base model, namely the denoising network 804 can be frozen when training the ControlNet encoders. When the denoising network 804 is implemented as a U-Net model, the image input blocks 904 can be initialized from the base U-Net model, and the hint input blocks 902 can be randomly initialized. In such cases, after the denoising network 804 is pre-trained as described above in conjunction with FIG. 8, the model trainer 116 can freeze the model parameters of the denoising network 804 and introduce an additional encoder, namely the image input blocks 904, whose parameters are partially initialized from the first half of the denoising network 804 U-Net. As the control input, such as depth and sketch maps, may have different dimensions from images, several extra blocks, namely the hint input blocks 902, are added to transform the control input into feature maps that will be added to the features from the noisy image input. Additionally, by scaling the control input feature maps (i.e., control weight), the controllability of different strengths can be achieved. Inpainting can be viewed as another controlled image generation problem, similar to sketch and depth controlled generation, with the partial image and inpainting mask as the control input. Three sub-tasks for inpainting are the replace, inpaint, and outpaint sub-tasks. In the replace sub-task, the unknown area in an image is an entire semantic area, which means the mask shape strictly follows the object shape. The replace sub-task is useful for replacing objects or backgrounds without changing an object shape. In the inpaint sub-task, the unknown area is not a semantic area and could partially cover both the background and foreground. In the outpaint sub-task, the unknown area is at the image boundary, which can also be viewed as a special case of inpainting. In some embodiments, one shared inpainting model is trained for all sub-tasks, and a one-hot vector is used to indicate different tasks, which is expanded to the image size and concatenated with the masked image and inpainting mask to serve as the control input.

In some embodiments, the model trainer 116 computes Canny edges, holistically-nested edge detection (HED) edges, and depth maps from input RGB images and uses the computed results to train edge and depth-to-image models. For inpainting, the model trainer 116 can generate random masks or use object masks to train an inpainting model. In such cases, the model trainer 116 can train only the additional encoder and keep the base model (e.g., denoising network 804) frozen during training.

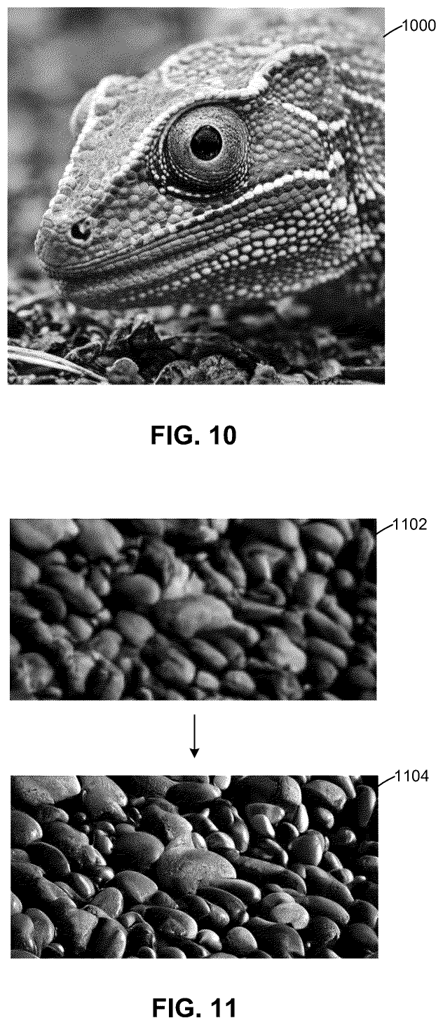

FIG. 10 illustrates an exemplar image generated using a Laplacian diffusion model, according to various embodiments. As shown, a 1024 resolution image 1000 of a chameleon can be generated using the Laplacian diffusion model 150 of FIG. 5, which is capable of text-to-image generation, among other things. The image 1000 was generated from the input text prompt “A chameleon showing colorful scales.” Experience has shown that the Laplacian diffusion model 150 is able to generate highly detailed photorealistic images adhering to an input text prompt across a diverse set of categories—nature, humans, animals, food, etc. The Laplacian diffusion model 150 can also generate images adhering to long and descriptive captions. In addition, camera control is enabled by conditioning the image generation on, e.g., pitch of the camera such as ascending, eye level, and descending views; depth of field; etc.

FIG. 11 illustrates an exemplar upsampling of an image using a Laplacian diffusion model, according to various embodiments. As shown, a 1024 (1K) resolution image 1102 can be upsampled to a 4K image 1104 using a Laplacian diffusion model. Illustratively, the 4K image 1104 adds additional fine-grained details to the 1K resolution image 1102.

In some embodiments, the image generating application 146 can start with a low-resolution image, resize the low-resolution image to a desired resolution, add noise to the re-sized image based on the forward diffusion process described above in conjunction with FIG. 6, and denoise the noisy re-sized image iteratively using the base model (e.g., a 1 K model) to obtain the upsampled image. One issue with such an approach, however, is that the model may change the content in the initial low-resolution image to a degree that may not be desirable to the user. To overcome this challenge, in some embodiments, the upsampler model can be designed as a ControlNet which conditions the base model on the clean low-resolution input image. In such cases, the model trainer 116 can fine-tune the base model with the low-resolution ControlNet on a smaller number of high-resolution images (e.g., 4K images) that are available. Doing so helps the model in two ways. First, the pre-trained base model has not seen any high-frequency content which is needed for generating high-resolution images. Fine-tuning on the high-resolution images enables the model to generate such details. Second, the clean low-resolution image conditioning allows the model to access the original content of the noisy input image and prevents the model from deviating too much from the original image.

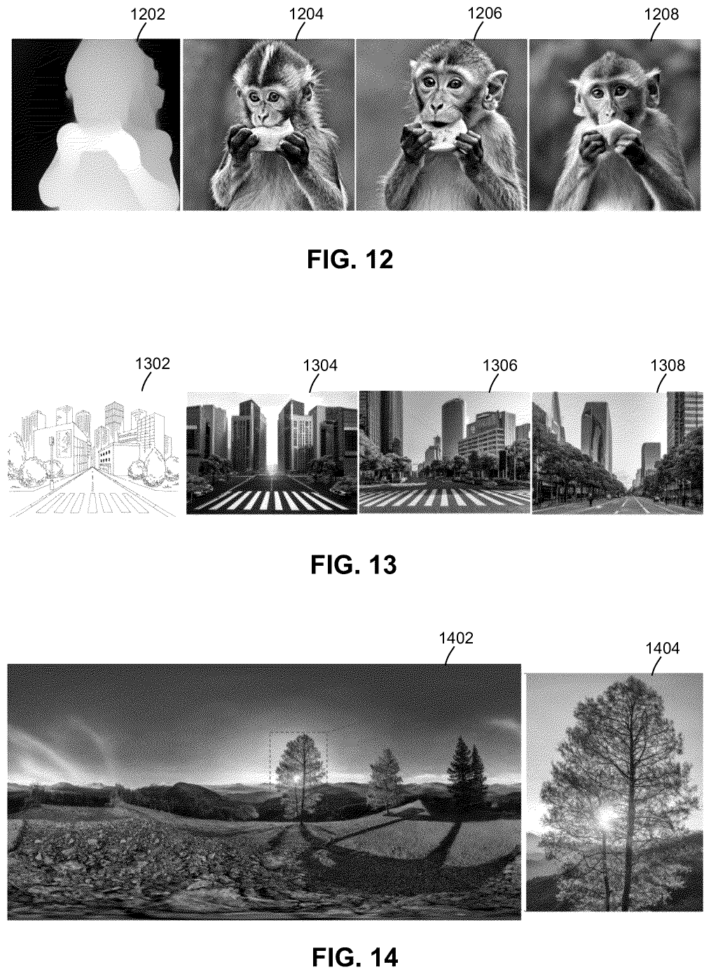

FIG. 12 illustrates exemplar images generated using a Laplacian diffusion model conditioned on depth information, according to various embodiments. As shown, given a depth map 1202 indicating the depths of pixels in the depth map 1202, a depth-to-image Laplacian diffusion model that includes ControlNet encoders, as described above in conjunction with FIG. 9, can be used to generate images 1204, 1206, and 1208 controlled by the depth map 1202. Illustratively, the images 1204, 1206, and 1208 are generated using different control weight values, with the image 1204 being generated using the highest depth strength and the image 1208 being generated using the lowest depth strength.

FIG. 13 illustrates exemplar images generated using a Laplacian diffusion model conditioned on edge information, according to various embodiments. As shown, given edge information 1302 in the form of a sketch, an edge-to-image Laplacian diffusion model that includes ControlNet encoders, as described above in conjunction with FIG. 9, can be used to generate images 1304, 1306, and 1308 controlled by the edge information 1302. Illustratively, the images 1304, 1306, and 1308 are generated using different control weight values, with the image 1304 being generated using the highest sketch strength and the image 1308 being generated using the lowest sketch strength.

FIG. 14 illustrates an exemplar panoramic image generated using a Laplacian diffusion model, according to various embodiments. As shown, a panoramic image 1402 has been generated using a Laplacian diffusion model that includes one or more diffusion models that each include a ControlNet encoder. As described, each diffusion model in a Laplacian diffusion model can include a ControlNet encoder that permits the generation of images based on conditioning information. In some embodiments, the conditioning information can include an image for which an image of a neighboring region is to be generated, and images of neighboring regions can be generated in a successive manner and stitched together to generate a panoramic image, such as the panoramic image 1402. For example, the image 1404 could be used to generate images of neighboring regions above, below, to the left, and to the right of the image 1404 within the panoramic image 1402, and such images of neighboring regions can be stitched together to form the panoramic image 1402. Accordingly, the image generating application 146 essentially performs sequential in-painting to generate views of neighboring regions that can be stitched together to form the panoramic image 1402.

In some embodiments, the Laplacian diffusion model used to generate the panoramic image 1402 can be a high-dynamic range (HDR) 360-degree panorama generator. Given a text prompt and (optionally) a corresponding example image from a single viewpoint, the Laplacian diffusion model generates omnidirectional equirectangular projection panoramas at a given resolution (e.g., 4K, 8K, or 16K resolution). The generated panoramas can provide content for 3D virtual reality headsets, backdrops for movies and games, and/or the like. Due to the high-dynamic range output, the generated panoramas can also be used as image-based lighting (IBL).

Unlike the case of images, which are cheap to obtain and available at scale on the Internet, gathering HDR panoramas can be time-consuming. A single panorama requires capturing and combining multiple images across different directions and exposure levels. The amount of available HDR panorama data is orders of magnitude less than that used to train successful foundation image models. To address the data limitation with respect to HDR panoramas, the image generating application 146 can use a base Laplacian diffusion model to provide a general text-to-image capability and assemble multiple generated images into the desired panorama. Limited panorama data can be used to fine-tune this technique and for HDR estimation.

In some embodiments, the image generating application 146 adopts a sequential inpainting approach in which a number of conventional perspective images are synthesized with a Laplacian diffusion model and stitched together, with overlap from preceding images, to ensure continuity. In such cases, during synthesis, each image is warped into equirectangular coordinates and projected into the coordinates of the neighboring image to provide the overlap region. The zenith (sky) and nadir (ground) images are also inpainted with overlaps from all longitudinal images. In some embodiments, the inpainting can be trained as a ControlNet, with an image including the overlap area providing the control signal. After generating a panoramic image, the panoramic image can be input into an LDR2HDR network to convert a low dynamic range (LDR) panoramic image to an HDR panoramic image. In some embodiments, the LDR2HDR network is a multi-scale U-Net that first generates a low-resolution HDR image and then concatenates the low-resolution HDR image with the high-resolution LDR input to generate the high-resolution HDR output. To train such a network, the model trainer 116 can convert a ground truth HDR dataset into LDR images and ask the network to reconstruct the original HDR input. For better training stability, the model trainer 116 can train the network to predict intensity values in logarithmic space. After training, the network is able to generate consistent panoramic scenes that properly follow the input prompt, allowing the synthesis of fine details for the trees, grass, etc., which are essential to make the results look realistic.

Illustratively, the panoramic image 1402 has been generated in HDR from LDR input. In the panoramic image 1402, high-intensity values have been correctly assigned to bright objects such as the sun and clouds. In addition, a wide dynamic range (e.g., 19 stops) of intensities have been predicted, which can be useful for image-based lighting applications.

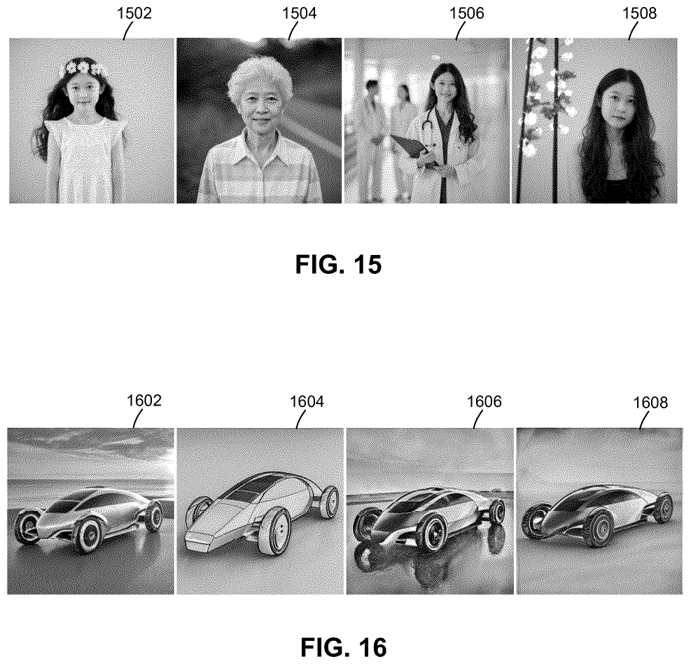

FIG. 15 illustrates exemplar images of a same subject generated using a Laplacian diffusion model, according to various embodiments. As shown, realistic images 1502, 1504, 1506, and 1508 of the same individual at different ages and in a variety of scenarios can be generated using a fine-tuned version of a Laplacian diffusion model. In some embodiments, the Laplacian diffusion model can be fine-tuned without modifying the architecture of the Laplacian diffusion model, and text encoders of the Laplacian diffusion model can be kept frozen. When the Laplacian diffusion model includes a U-Net architecture, the model trainer 116 can fine tune only a subset of parameters in the cross-attention layers of the U-Net, which accounts for a small percentage of the total U-Net parameters. In some embodiments, the Laplacian diffusion model can be fine-tuned for different datasets associated with various customization tasks, such as single-subject personalization, multi-subject personalization, single-subject stylization, or multi-subject stylization. By fine-tuning the Laplacian diffusion model on images of a single subject, the fine-tuned Laplacian diffusion model can generate images of the subject at different ages and in various outfits, none of which were included in the training data. The fine-tuned model can also be integrated with pre-trained, frozen ControlNet modules. In some embodiments, the Laplacian diffusion model can also be fine-tuned on a dataset that includes multiple subjects. In such cases, to distinguish between the multiple subjects, distinct names can be used for each individual in the training prompts.

FIG. 16 illustrates exemplar images with different styles that are generated using a Laplacian diffusion model, according to various embodiments. As shown, images 1602, 1604, 1606, and 1608 have been generated in the “Epic,” “Line Art,” “Watercolor,” and “Comic Sketch” styles, respectively. As described, a Laplacian diffusion model can be fine-tuned for different datasets associated with various customization tasks, such as single-subject personalization, multi-subject personalization, single-subject stylization, and multi-subject stylization. In some embodiments, the Laplacian diffusion model can be fine-tuned for single-subject stylization using a dataset of the same subject with different stylizations to enable the Laplacian diffusion model to learn multiple styles. In such cases, different style names, such as “Epic” and “Line Art” can be used in the training prompts to help the model distinguish among various styles.

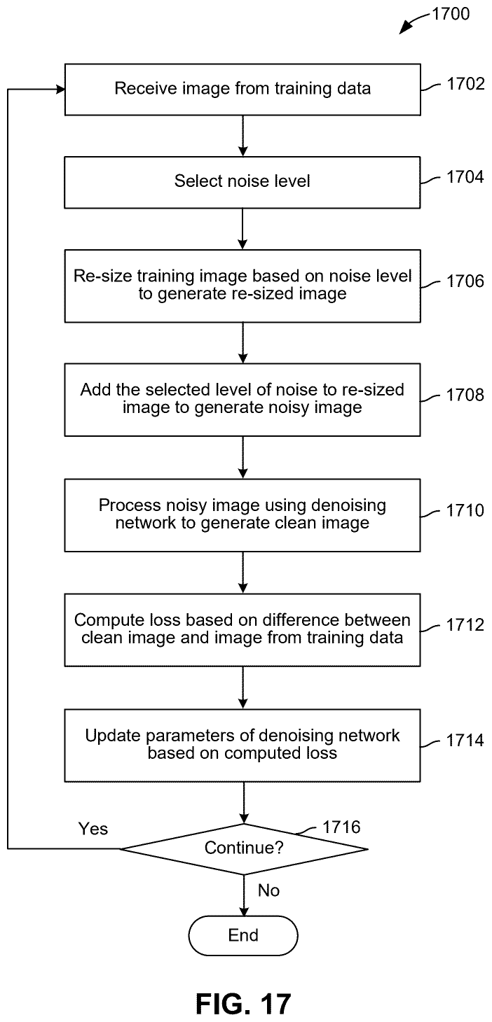

FIG. 17 is a flow diagram of method steps for training a Laplacian diffusion model, according to various embodiments. Although the method steps are described in conjunction with the embodiments of FIGS. 1-16, persons skilled in the art will understand that any system configured to perform the method steps in any order falls within the scope of the present embodiments.

As shown, a method 1700 begins at step 1702, where the model trainer 116 receives an image from training data. Any suitable image can be used in some embodiments.

At step 1704, the model trainer 116 selects a noise level. As described, different resolutions can be associated with different noise levels in some embodiments.

At step 1706, the model trainer 116 re-sizes the training image based on the noise level to generate a re-sized image. Then, at step 1708, the model trainer 116 adds the selected level of noise to the re-sized image to generate a noisy image. In some embodiments, more noise can be added for re-sized images that are lower resolution, and less noise can be added for re-sized images that are higher resolution. The intuition behind this approach is that at high noise levels, high frequency details cannot be deciphered and only a blurred shape can be determined, so it makes sense to learn at a low resolution rather than a high resolution.

At step 1710, the model trainer 116 processes the noisy image using a denoising network (e.g., denoising network 804) to generate a clean image. Any technically feasible denoising network, such as a neural network having a U-Net architecture, can be used in some embodiments. The denoising network is configured to take as input a noisy image and generate a clean image. In some embodiments, a wavelet transform module (e.g., wavelet transform module 802) performs a wavelet transform on the noisy image prior to downsample the noisy image to a lower resolution before the lower-resolution image is input into the denoising network. In some embodiments, an inverse wavelet transform module (e.g., inverse wavelet transform module 808) performs an inverse wavelet transform on the clean image output by the denoising network to generate a higher resolution (i.e., upsampled) image.

In some embodiments, when the denoising network includes a U-Net-based architecture, the U-Net architecture can include a sequence of residual and attention blocks that progressively downsample (or upsample) feature maps with skip connections. For high-resolution synthesis, the spatial resolution of feature maps increases, which makes the computation of attention maps expensive. To address such an issue, the diffusion model can operate on the smaller spatial resolution by using invertible wavelet transforms, namely wavelet transforms by the wavelet transform modules and, at the beginning and the end of the denoising network. In some embodiments, 2-level Haar wavelets can be used to downsample the images in the pixel space from resolution (3×H×W) to (48×(H/4)×(W/4)). Doing so reduces the number of spatial tokens in the attention layers of the denoising network 804 by a factor of 16, dramatically improving the training efficiency.

At step 1712, the model trainer 116 computes a loss based on a difference between the clean image and the image from the training data. In some embodiments, the loss can be computed according to Equation (1).

At step 1714, the model trainer 116 updates parameters of the denoising network based on the computed loss. The model trainer 116 can use any technically feasible training algorithm in some embodiments, such as backpropagation with gradient descent or a variation thereof, to update parameters of the denoising network.

At step 1716, if the model trainer 116 determines to continue training, then the method 1700 returns to step 1702, where the model trainer 116 receives another image from the training data. The model trainer 116 can determine whether to continue training in any technically feasible manner, such as based on a fixed number of training iterations, based on whether a loss plateaus, and/or the like. On the other hand, if the model trainer 116 determines not to continue training, then the method 1700 ends. Although the method 1700 assumes that the Laplacian diffusion model includes one diffusion model (e.g., one of diffusion models 408), in some embodiments, the steps 1702-1716 can be repeated to train multiple diffusion models of a Laplacian diffusion model for different time intervals, as described above in conjunction with FIG. 6.

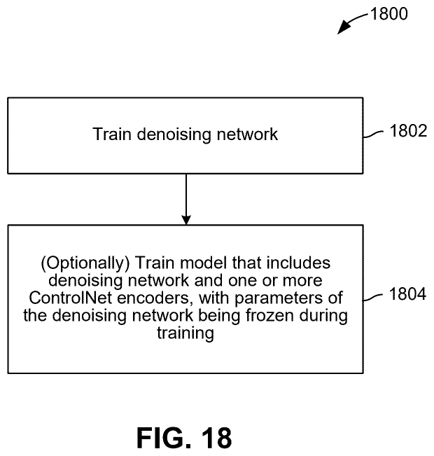

FIG. 18 is a flow diagram of method steps for fine tuning a Laplacian diffusion model, according to various embodiments. Although the method steps are described in conjunction with the embodiments of FIGS. 1-16, persons skilled in the art will understand that any system configured to perform the method steps in any order falls within the scope of the present embodiments.

As shown, a method 1800 begins at step 1802, where the model trainer 116 trains a denoising network. In some embodiments, the denoising network can be trained according to steps of the method 1700, described above in conjunction with FIG. 17.

At step 1804, the model trainer 116 optionally trains a model that includes the denoising network and one or more ControlNet encoders, with parameters of the denoising network being frozen during the training. As described, the ControlNet encoders can permit the generation of images in various styles and/or based on various conditioning information, such as a lower-resolution image, depth information, or edge information. In some embodiments, the conditioning information can include an image for which an image of a neighboring region is to be generated, and images of neighboring regions can be generated in a successive manner and stitched together to generate a panoramic image.

In some embodiments, the model can be fine-tuned without modifying the architecture of the model by, e.g., updating a subset of parameters of the model. When the model includes a U-Net architecture, the model trainer 116 can fine tune only a subset of parameters in the cross-attention layers of the U-Net, which accounts for a small percentage of the total U-Net parameters. In some embodiments, the model can be fine-tuned for different datasets associated with various customization tasks, such as single-subject personalization, multi-subject personalization, single-subject stylization, or multi-subject stylization, as described above in conjunction with FIG. 15.

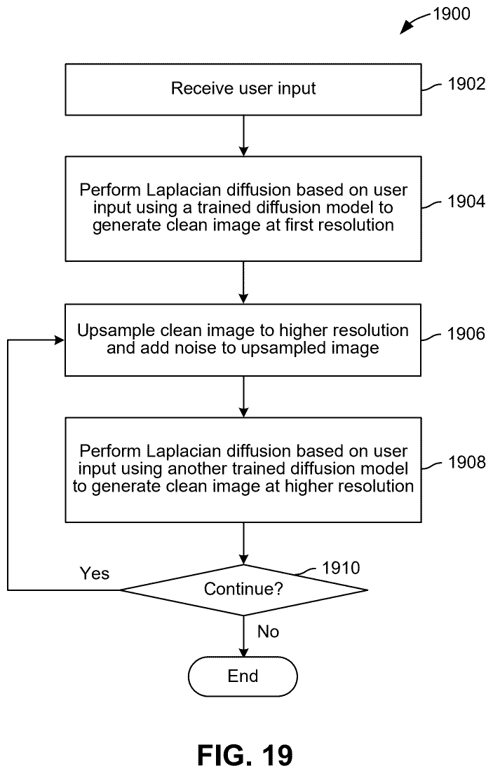

FIG. 19 is a flow diagram of method steps for generating an image using a Laplacian diffusion model, according to various embodiments. Although the method steps are described in conjunction with the embodiments of FIGS. 1-16, persons skilled in the art will understand that any system configured to perform the method steps in any order falls within the scope of the present embodiments.

As shown, a method 1900 begins at step 1902, where the image generating application 146 receives a user input. In some embodiments, any suitable user input, such as text, camera parameters, a media type, a lower-resolution image, depth information, and/or edge information can be received and used to condition the image generation.

At step 1904, the image generating application 146 performs Laplacian diffusion based on the user input and using a trained diffusion model to generate a clean image at a first resolution. In some embodiments, the Laplacian diffusion can include progressively denoising images via denoising diffusion and upsampling the images to higher resolutions at the same time, as described above in conjunction with FIG. 4. In some embodiments, the trained diffusion model can include ControlNet encoders that enable the image generation to be conditioned on additional inputs, as described above in conjunction with FIGS. 9 and 11-14.

At step 1906, the image generating application 146 upsamples the clean image to a higher resolution and performs forward diffusion to add noise to the upsampled image. In some embodiments, the forward diffusion can be performed as described above in conjunction with FIGS. 5-6.

At step 1908, the image generating application 146 performs Laplacian diffusion based on the user input and using another trained diffusion model to generate another clean image at the higher resolution. In some embodiments, the other trained diffusion model is an upsampler model, such as one of the upsampler diffusion models 408 described above in conjunction with FIG. 5. In some embodiments, the Laplacian diffusion can include progressively denoising images via denoising diffusion and upsampling the images to higher resolutions at the same time, as described above in conjunction with FIG. 4.

At step 1910, if the image generating application 146 determines to continue to a next higher resolution, then the method 1900 returns to step 1906, where the image generating application 146 again upsamples the clean image to the next higher resolution and adds noise to the upsampled image. On the other hand, if the image generating application 146 determines not to continue, then method 1900 ends. In some other embodiments, a Laplacian diffusion model may include only a single diffusion model, in which case only step 1904 would be performed after receiving user input at step 1902.

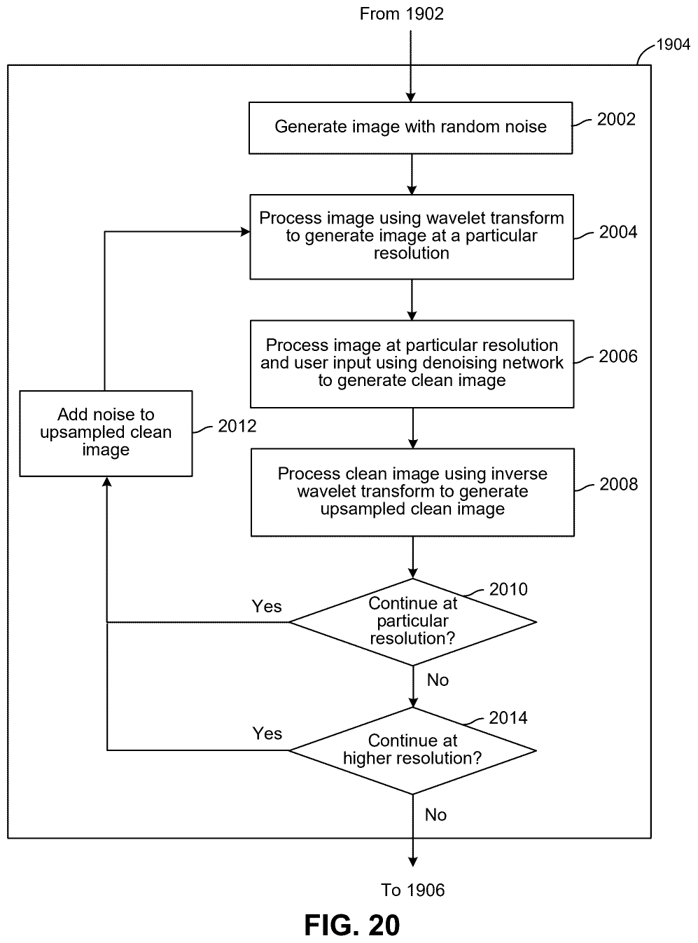

FIG. 20 is a flow diagram of method steps for performing Laplacian diffusion to generate an image at a first resolution, according to various embodiments. Although the method steps are described in conjunction with the embodiments of FIGS. 1-16, persons skilled in the art will understand that any system configured to perform the method steps in any order falls within the scope of the present embodiments.

As shown, step 1904 begins at step 2002, where the image generating application 146 generates an image that includes random noise.

At step 2004, the image generating application 146 processes the image using a wavelet transform to generate an image at a particular resolution. Any technically feasible wavelet transform, such as a Haar wavelet transform, can be used in some embodiments. In some embodiments, 2-level Haar wavelets can be used to downsample the images in the pixel space from resolution (3×H×W) to (48×(H/4)×(W/4)), as described above in conjunction with FIG. 8. Initially, the particular resolution to which the noisy image is downsampled can be a relatively low resolution, such as a 32 resolution image.

At step 2006, the image generating application 146 processes the image at the particular resolution and the user input using a denoising network (e.g., denoising network 804) to generate a clean image. As described above in conjunction with FIGS. 8-9, in some embodiments, the denoising network can include a U-Net-based architecture. In such cases, the U-Net architecture can include a sequence of residual and attention blocks that progressively downsample (or upsample) feature maps with skip connections. For high-resolution synthesis, the spatial resolution of feature maps increases, which makes the computation of attention maps expensive. To address such an issue, the diffusion model can operate on the smaller spatial resolution by using invertible wavelet transforms at the beginning and the end of the denoising network.

At step 2008, the image generating application 146 processes the clean image using an inverse wavelet transform to generate an upsampled clean image. Any technically feasible inverse wavelet transform, such as an inverse Haar wavelet transform, can be used in some embodiments.

At step 2010, if the image generating application 146 determines to continue iterating at the particular resolution, then at step 2012, the image generating application 146 adds noise to the upsampled clean image. The amount of noise added depends on the particular resolution, with more noise being added for lower resolutions and less noise being added for higher resolutions. Then, the method 1900 returns to step 2004, where the image generating application 146 processes the noisy upsampled image using a wavelet transform to generate another image at the particular resolution.

On the other hand, if the image generating application 146 determines not to continue at the particular resolution, then at step 2014, the image generating application 146 determines whether to continue at a higher resolution. If the particular resolution is already a highest resolution for a diffusion model being used (e.g., 256 resolution for a base model that generates images at 256 resolution), then the image generating application 146 can determine not to continue at a higher resolution. In such a case, the method 1900 continues to step 1906. On the other hand, if the particular resolution is not the highest resolution for the diffusion model being used, then the image generating application 146 can determine to continue at a higher resolution. In such a case, the method 1900 proceeds directly to step 2012, where the image generating application 146 adds noise to the upsampled clean image based on the higher resolution, which is now the particular resolution being used. The amount of noise added depends on the higher resolution, with more noise being added for lower resolutions and less noise being added for higher resolutions.

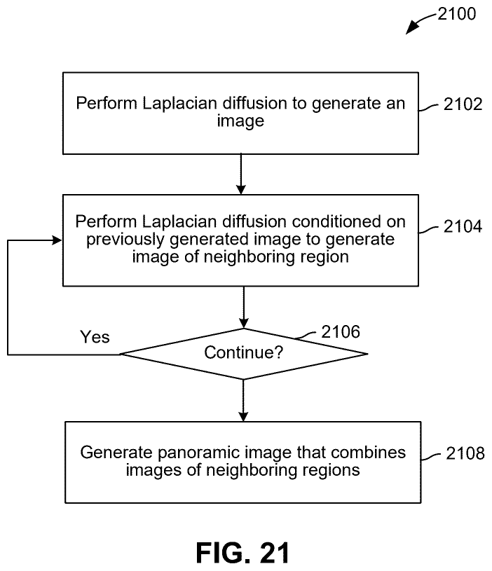

FIG. 21 is a flow diagram of method steps for generating panoramic images, according to various embodiments. Although the method steps are described in conjunction with the embodiments of FIGS. 1-16, persons skilled in the art will understand that any system configured to perform the method steps in any order falls within the scope of the present embodiments.

As shown, a method 2100 begins at step 2102, where the image generating application 146 performs Laplacian diffusion to generate an image. In some embodiments, the image generating application 146 can perform Laplacian diffusion according to the steps 1902-1908, described above in conjunction with FIG. 19.

At step 2104, the image generating application 146 performs Laplacian diffusion conditioned on a previously generated image to generate an image of a neighboring region. As described above in conjunction with FIG. 14, one or more diffusion models in a Laplacian diffusion model can each include a ControlNet encoder that permits the generation of images based on conditioning information. In some embodiments, the conditioning information can include an image for which an image of a neighboring region is to be generated, and images of neighboring regions can be generated in a successive manner and stitched together to generate a panoramic image. More specifically, in some embodiments, the image generating application 146 adopts a sequential inpainting approach in which a number of conventional perspective images are synthesized with a Laplacian diffusion model and stitched together, with overlap from preceding images, to ensure continuity. In such cases, during synthesis, each image is warped into equirectangular coordinates and projected into the coordinates of the neighboring image to provide the overlap region. The zenith (sky) and nadir (ground) images are also inpainted with overlaps from all longitudinal images. In some embodiments, the inpainting can be trained as a ControlNet, with an image including the overlap area providing the control signal.

In some embodiments, the Laplacian diffusion model used to generate the panoramic image can be an HDR 360-degree panorama generator. Given a text prompt and (optionally) a corresponding example image from a single viewpoint, the Laplacian diffusion model generates omnidirectional equirectangular projection panoramas at a given resolution (e.g., 4K, 8K, or 16K resolution). In some embodiments, after generating a panoramic image, the image generating application 146 can input the panoramic image into an LDR2HDR network to convert an LDR panoramic image to an HDR panoramic image. In some embodiments, the LDR2HDR network is a multi-scale U-Net that first generates a low-resolution HDR image and then concatenates the low-resolution HDR image with the high-resolution LDR input to generate the high-resolution HDR output, as described above in conjunction with FIG. 14.

At step 2106, if the image generating application 146 determines to continue generating images of neighboring regions, then the method 2100 returns to step 2104, where the image generating application 146 again performs Laplacian diffusion conditioned on a previously generated image, which would be an image generated at step 2104, to generate an image of a neighboring region.

On the other hand, if the image generating application 146 determines not to continue generating images of neighboring regions, then the method 2100 proceeds directly to step 2108, where the image generating application 146 generates a panoramic image that combines the previously generated images of neighboring regions. As described, generating the panoramic image can include stitching together images of neighboring view, with overlap to ensure continuity.

In sum, embodiments of the present disclosure provide techniques for generating images using Laplacian diffusion. In some embodiments, an image generating application includes one or more diffusion models that each perform a Laplacian diffusion technique that includes progressively denoising images and upsampling the images to higher resolutions at the same time. When multiple diffusion models are used, one diffusion model can generate an image at a low resolution. The image generating application upsamples the generated image to a higher resolution and performs forward diffusion to add noise to the upsampled image. Another diffusion model begins Laplacian diffusion from the noisy upsampled image to generate another image. The foregoing steps can be repeated any number of times to generate images at increasingly higher resolutions. In some embodiments, each diffusion model can include one or more encoders, such as ControlNet encoders, that permit the generation of images in various styles and/or based on various conditioning information, such as a lower-resolution image, depth information, or edge information. In some embodiments, the conditioning information can include an image for which an image of a neighboring region is to be generated, and images of neighboring regions can be generated in a successive manner and stitched together to generate a panoramic image.

To train a diffusion model, a model trainer receives an image from training data. The model trainer re-sizes the training image based on a randomly selected noise level to generate a re-sized image. The model trainer adds the selected level of noise to the re-sized image to generate a noisy image. The model trainer processes the noisy image using a denoising network to generate a clean image. Then, the model trainer computes a loss based on a difference between the clean image and the image from the training data, and the model trainer updates parameters of the denoising network based on the computed loss. The foregoing steps can be repeated for multiple training images to train the diffusion model. Thereafter, the model trainer can fine-tune the trained diffusion model for higher resolutions to generate other trained diffusion models. Optionally, the model trainer can also train one or more models that include the trained denoising network and one or more ControlNet encoders by updating parameters of the ControlNet encoder(s) while keeping parameters of the trained denoising network frozen during the training.

To train the diffusion model, a model trainer receives an image from training data. The model trainer re-sizes the training image based on a randomly selected noise level to generate a re-sized image. The model trainer adds the selected level of noise to the re-sized image to generate a noisy image. The model trainer processes the noisy image using a denoising network to generate a clean image. Then, the model trainer computes a loss based on a difference between the clean image and the image from the training data, and the model trainer updates parameters of the denoising network based on the computed loss. The foregoing steps can be repeated for multiple training images to train the diffusion model. Thereafter, the model trainer can optionally train a model that includes the trained denoising network and a ControlNet encoder by updating parameters of the ControlNet encoder while keeping parameters of the trained denoising network frozen during the training.

At least one technical advantage of the disclosed techniques relative to the prior art is that the disclosed techniques can generate high-resolution images, including 4K images and panoramic images. In addition, the disclosed techniques can generate images with fewer artifacts relative to images generated using conventional diffusion models. For example, the disclosed techniques can generate relatively realistic and high-resolution images of humans. These technical advantages represent one or more technological improvements over prior art approaches.
1. In some embodiments, a computer-implemented method for generating images comprises performing, based on one or more inputs, one or more first denoising diffusion operations using a first trained machine learning model to generate a first image at a first resolution, and performing, based on the one or more inputs and the first image, one or more second denoising diffusion operations using a second trained machine learning model to generate a second image at a second resolution.
2. The computer-implemented method of clause 1, further comprising upsampling the first image to the second resolution to generate an upsampled image, and adding noise to the upsampled image to generate a noisy image, wherein the one or more second denoising diffusion operations are performed from the noisy image.
3. The computer-implemented method of clauses 1 or 2, wherein adding noise to the upsampled image comprises performing one or more forward diffusion operations on the upsampled image.
4. The computer-implemented method of any of clauses 1-3, wherein the first trained machine learning model is the second trained machine learning model.
5. The computer-implemented method of any of clauses 1-4, wherein performing the one or more first denoising diffusion operations comprises processing a third image using a wavelet transform to generate a fourth image, wherein the third image comprises noise, processing the fourth image using the first trained machine learning model to generate a fifth image, and processing the fifth image using an inverse wavelet transform to generate the first image.
6. The computer-implemented method of any of clauses 1-5, wherein the fourth image comprises a clean image.
7. The computer-implemented method of any of clauses 1-6, wherein the second resolution is higher than the first resolution.
8. The computer-implemented method of any of clauses 1-7, wherein the one or more inputs include a third image, and the method further comprises generating a panoramic image based on the second image and the third image.
9. The computer-implemented method of any of clauses 1-8, wherein the one or more inputs include at least one of text, a third image, depth information, edge information, camera information, or media type information.
10. The computer-implemented method of any of clauses 1-9, wherein the first trained machine learning model comprises a first ControlNet encoder, and wherein the second trained machine learning model comprises a second ControlNet encoder.
11. In some embodiments, one or more non-transitory computer-readable media store instructions that, when executed by at least one processor, cause the at least one processor to perform the steps of performing, based on one or more inputs, one or more first denoising diffusion operations using a first trained machine learning model to generate a first image at a first resolution, and performing, based on the one or more inputs and the first image, one or more second denoising diffusion operations using a second trained machine learning model to generate a second image at a second resolution.
12. The one or more non-transitory computer-readable media of clause 11, wherein the instructions, when executed by the at least one processor, further cause the at least one processor to perform the steps of upsampling the first image to the second resolution to generate an upsampled image, and adding noise to the upsampled image to generate a noisy image, wherein the one or more second denoising diffusion operations are performed from the noisy image.
13. The one or more non-transitory computer-readable media of clauses 11 or 12, wherein adding noise to the upsampled image comprises performing one or more forward diffusion operations on the upsampled image.
14. The one or more non-transitory computer-readable media of any of clauses 11-13, wherein the first trained machine learning model is the second trained machine learning model.
15. The one or more non-transitory computer-readable media of any of clauses 11-14, wherein performing the one or more first denoising diffusion operations comprises processing a third image using a wavelet transform to generate a fourth image, wherein the third image comprises noise, processing the fourth image using the first trained machine learning model to generate a fifth image, and processing the fifth image using an inverse wavelet transform to generate the first image.
16. The one or more non-transitory computer-readable media of any of clauses 11-15, wherein the second resolution is higher than the first resolution.
17. The one or more non-transitory computer-readable media of any of clauses 11-16, wherein the first trained machine learning model comprises a first encoder-decoder model, and wherein the second trained machine learning model comprises a second encoder-decoder model.
18. The one or more non-transitory computer-readable media of any of clauses 11-17, wherein the first trained machine learning model is fine-tuned on training data associated with at least one of an individual or a style.
19. The one or more non-transitory computer-readable media of any of clauses 11-18, wherein the instructions, when executed by the at least one processor, further cause the at least one processor to perform the step of performing, based on the one or more user inputs and the second image, one or more third denoising diffusion operations using a third trained machine learning model to generate a third image at a third resolution.
20. In some embodiments, a system comprises one or more memories storing instructions, and one or more processors that are coupled to the one or more memories and, when executing the instructions, are configured to perform, based on one or more inputs, one or more first denoising diffusion operations using a first trained machine learning model to generate a first image at a first resolution, and perform, based on the one or more inputs and the first image, one or more second denoising diffusion operations using a second trained machine learning model to generate a second image at a second resolution.
1. In some embodiments, a computer-implemented method for training a machine learning model comprises re-sizing a training image based on a selected noise level to generate a re-sized image, adding noise of the selected noise level to the re-sized image to generate a noisy image, processing the noisy image using a first untrained machine learning model to generate a clean image, and updating one or more parameters of the first untrained machine learning model based on the training image and the clean image to generate a first trained machine learning model, wherein the first trained machine learning model performs one or more denoising diffusion operations at a plurality of resolutions to generate a first image.
2. The computer-implemented method of clause 1, wherein the first trained machine learning model comprises a wavelet transform, a neural network, and an inverse wavelet transform.
3. The computer-implemented method of clauses 1 or 2, wherein the first trained machine learning model comprises a denoising neural network.
4. The computer-implemented method of any of clauses 1-3, further comprising performing one or more operations to train a second untrained machine learning model that comprises the first trained machine learning model and one or more untrained encoders to generate a second trained machine learning model.
5. The computer-implemented method of any of clauses 1-4, wherein the one or more untrained encoders include one or more ControlNet encoders.
6. The computer-implemented method of any of clauses 1-5, wherein the one or more operations to train the second untrained machine learning model are based on at least one of one or more additional images that are higher resolution than the training image, one or more panoramic images, one or more high dynamic range (HDR) images, edges associated with one or more images, depth maps associated with one or more images, or one or more images of a particular subject.
7. The computer-implemented method of any of clauses 1-6, wherein the one or more parameters of the first untrained machine learning model are updated based on a difference between the training image and the clean image.
8. The computer-implemented method of any of clauses 1-7, further comprising selecting the selected noise level randomly.
9. The computer-implemented method of any of clauses 1-8, wherein the first image is at a first resolution, and a second trained machine learning model performs one or more denoising diffusion operations based on the first image to generate a second image at a second resolution.
10. The computer-implemented method of any of clauses 1-9, wherein the first trained machine learning model is trained to process images having a larger noise range than images that the second trained machine learning model is trained to process.
11. In some embodiments, one or more non-transitory computer-readable media store instructions that, when executed by at least one processor, cause the at least one processor to perform the steps of re-sizing a training image based on a selected noise level to generate a re-sized image, adding noise of the selected noise level to the re-sized image to generate a noisy image, processing the noisy image using a first untrained machine learning model to generate a clean image, and updating one or more parameters of the first untrained machine learning model based on the training image and the clean image to generate a first trained machine learning model, wherein the first trained machine learning model performs one or more denoising diffusion operations at a plurality of resolutions to generate a first image.
12. The one or more non-transitory computer-readable media of clause 11, wherein the first trained machine learning model comprises a wavelet transform, a neural network, and an inverse wavelet transform.
13. The one or more non-transitory computer-readable media of clauses 11 or 12, further comprising performing one or more operations to train a second untrained machine learning model that comprises the first trained machine learning model and one or more untrained encoders to generate a second trained machine learning model.
14. The one or more non-transitory computer-readable media of any of clauses 11-13, wherein the one or more operations to train the second untrained machine learning model are based on at least one of one or more additional images that are higher resolution than the training image, one or more panoramic images, one or more high dynamic range (HDR) images, edges associated with one or more images, depth maps associated with one or more images, or one or more images of a particular subject.
15. The one or more non-transitory computer-readable media of any of clauses 11-14, wherein the one or more parameters of the first untrained machine learning model are updated based on a difference between the training image and the clean image.
16. The one or more non-transitory computer-readable media of any of clauses 11-15, wherein the first image is at a first resolution, and a second trained machine learning model performs one or more denoising diffusion operations based on the first image to generate a second image at a second resolution.
17. The one or more non-transitory computer-readable media of any of clauses 11-16, wherein updating the one or more parameters of the first untrained machine learning model is further based on at least one text caption generated using a language model.
18. The one or more non-transitory computer-readable media of any of clauses 11-17, wherein the first trained machine learning model comprises a neural network having an encoder-decoder architecture.
19. The one or more non-transitory computer-readable media of any of clauses 11-18, wherein the first trained machine learning model comprises a neural network having a U-Net architecture.
20. In some embodiments, a system comprises one or more memories storing instructions, and one or more processors that are coupled to the one or more memories and, when executing the instructions, are configured to re-size a training image based on a selected noise level to generate a re-sized image, add noise of the selected noise level to the re-sized image to generate a noisy image, process the noisy image using an untrained machine learning model to generate a clean image, and update one or more parameters of the untrained machine learning model based on the training image and the clean image to generate a trained machine learning model, wherein the trained machine learning model performs one or more denoising diffusion operations at a plurality of resolutions to generate a first image.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating images, the method comprising:
performing, based on one or more inputs, one or more first denoising diffusion operations using a first trained machine learning model to generate a first image at a first resolution; and
performing, based on the one or more inputs and the first image, one or more second denoising diffusion operations using a second trained machine learning model to generate a second image at a second resolution.

2. The computer-implemented method of claim 1, further comprising:
upsampling the first image to the second resolution to generate an upsampled image; and
adding noise to the upsampled image to generate a noisy image,
wherein the one or more second denoising diffusion operations are performed from the noisy image.

3. The computer-implemented method of claim 2, wherein adding noise to the upsampled image comprises performing one or more forward diffusion operations on the upsampled image.

4. The computer-implemented method of claim 1, wherein the first trained machine learning model is the second trained machine learning model.

5. The computer-implemented method of claim 1, wherein performing the one or more first denoising diffusion operations comprises:
processing a third image using a wavelet transform to generate a fourth image, wherein the third image comprises noise;
processing the fourth image using the first trained machine learning model to generate a fifth image; and
processing the fifth image using an inverse wavelet transform to generate the first image.

6. The computer-implemented method of claim 5, wherein the fourth image comprises a clean image.

7. The computer-implemented method of claim 1, wherein the second resolution is higher than the first resolution.

8. The computer-implemented method of claim 1, wherein the one or more inputs include a third image, and the method further comprises generating a panoramic image based on the second image and the third image.

9. The computer-implemented method of claim 1, wherein the one or more inputs include at least one of text, a third image, depth information, edge information, camera information, or media type information.

10. The computer-implemented method of claim 1, wherein the first trained machine learning model comprises a first ControlNet encoder, and wherein the second trained machine learning model comprises a second ControlNet encoder.

11. One or more non-transitory computer-readable media storing instructions that, when executed by at least one processor, cause the at least one processor to perform the steps of:
performing, based on one or more inputs, one or more first denoising diffusion operations using a first trained machine learning model to generate a first image at a first resolution; and
performing, based on the one or more inputs and the first image, one or more second denoising diffusion operations using a second trained machine learning model to generate a second image at a second resolution.

12. The one or more non-transitory computer-readable media of claim 11, wherein the instructions, when executed by the at least one processor, further cause the at least one processor to perform the steps of:
upsampling the first image to the second resolution to generate an upsampled image; and
adding noise to the upsampled image to generate a noisy image,
wherein the one or more second denoising diffusion operations are performed from the noisy image.

13. The one or more non-transitory computer-readable media of claim 12, wherein adding noise to the upsampled image comprises performing one or more forward diffusion operations on the upsampled image.

14. The one or more non-transitory computer-readable media of claim 11, wherein the first trained machine learning model is the second trained machine learning model.

15. The one or more non-transitory computer-readable media of claim 11, wherein performing the one or more first denoising diffusion operations comprises:
processing a third image using a wavelet transform to generate a fourth image, wherein the third image comprises noise;
processing the fourth image using the first trained machine learning model to generate a fifth image; and
processing the fifth image using an inverse wavelet transform to generate the first image.

16. The one or more non-transitory computer-readable media of claim 11, wherein the second resolution is higher than the first resolution.

17. The one or more non-transitory computer-readable media of claim 11, wherein the first trained machine learning model comprises a first encoder-decoder model, and wherein the second trained machine learning model comprises a second encoder-decoder model.

18. The one or more non-transitory computer-readable media of claim 11, wherein the first trained machine learning model is fine-tuned on training data associated with at least one of an individual or a style.

19. The one or more non-transitory computer-readable media of claim 11, wherein the instructions, when executed by the at least one processor, further cause the at least one processor to perform the step of performing, based on the one or more user inputs and the second image, one or more third denoising diffusion operations using a third trained machine learning model to generate a third image at a third resolution.

20. A system, comprising:
one or more memories storing instructions; and
one or more processors that are coupled to the one or more memories and, when executing the instructions, are configured to:
perform, based on one or more inputs, one or more first denoising diffusion operations using a first trained machine learning model to generate a first image at a first resolution, and
perform, based on the one or more inputs and the first image, one or more second denoising diffusion operations using a second trained machine learning model to generate a second image at a second resolution.
